(19) United States
(12) Patent Application Publication
(10) Pub. No.: US 2012/0266479 A1
(43) Pub. Date: Oct. 25, 2012

(54) PORTABLE MEASURING INSTRUMENT

(76) Inventor: Se Beom Park, Seoul (KR)

(21) Appl. No.: 13/515,252

(22) PCT Filed: Dec. 7, 2010
(86) PCT No.: PCT/KR10/08712

§ 371 Date: Jun. 11, 2012

(30) Foreign Application Priority Data
Dec. 11, 2009 (KR) 10-2009-0123010
Oct. 26, 2010 (KR) 10-2010-0104639

(51) Int. Cl. G01B 5/02

(52) U.S. Cl. 33/712

(57) ABSTRACT

The present invention relates to a portable measuring instrument, comprising: a main body including a pair of measuring holders and a pair of handles, wherein the measuring holders have respective tips which are brought closer to one another or are spaced apart from one another, the measuring holders face each other to accommodate or release an object to be measured, and the handles enable the measuring holders to be spaced apart from one another; a rotating shaft which couples the measuring holders together such that the measuring holders are rotatable; and a measuring tape which passes through the tips of the respective measuring holders such that the measuring tape is wound/unwound onto/from the main body, wherein the measuring tape is coiled along the circumference of the object to be measured when the measuring holders are brought closer to one another or are spaced apart from one another, so as to measure the size of the object to be measured. Accordingly, a worker may measure the diameter of the object to be measured in a convenient manner using one hand, and the time required for the measurement can be shortened.

### TECHNICAL FIELD

The present invention relates to a portable measuring instrument, and in particular to a portable measuring instrument which makes it possible to easily measure the diameter of an object which will be measured.

### BACKGROUND ART

As life becomes abundance, people tend to have a big interest in designs, and at the same time landscape trees are widely used in an attempt to make environment comfortable to live with.

The prices of the trees for landscape are generally determined based on the types and sizes of trees.

The types of trees are generally determined in a visual manner, and the is sizes of trees are determined with the information on the height, the root diameter or the breast diameter of the tree. In particular, the root diameters and the breast diameters of trees are reliable standards in determining the prices of trees.

Unless the accurate standards of the trees are measured, there might be a severe price conflict between a producer and a customer.

Two methods are generally used for the purpose of measuring the diameters of trees.

First of all, there a method using a pi-tape measure with previously set diameters. Second of all, there is a method of measuring a diameter using a device such as a vernier calipers.

In the event that the diameters of trees are measured using the above-mentioned pi-tape or the vernier calipers, the area where trees exist is generally full of weeds and trees with rough barks or is generally slanted and has uneven grounds, the environments of which are bad enough for a worker to measure putting up with injuries and dangers.

In addition, when measuring the diameter of trees, it is needed to measure irrespective of the distances between neighboring trees. So, when a worker measures one by one even when the intervals of trees are narrow, the worker needs to crunch down, so it takes a worker a long time to measure, and the legs and back of the worker might be hurt.

### DISCLOSURE OF INVENTION

Accordingly, the present invention is made to resolve the problems encountered in the conventional art, and it is an object of the present invention to provide a portable measuring instrument which makes it possible to measure the diameter of an object which will be measured and makes it possible to shorten a measuring time.

To achieve the above objects, there is provided a potable measuring instrument which comprises a body which includes a pair of measuring holders which have tips coming into close contact with each other or coming distant from each other and are arranged opposite to each other for the purpose of accommodating or releasing an object which will be measured; and a pair of grips which enable the pair of the measuring holders to be spaced apart from each other; a rotary shaft which engages the pair of the measuring holders to be to rotatable; and a tape measure which crosses the tips of the pair of the measuring holders and is wound on or unwound from the body and surrounds the circumference of the object, which will be measured, as the pair of the measuring holders come into contact with or come distant from each other for thereby measuring the size of the object which will be measured.

Here, there is further provided an elastic part which provides an elastic force so that each tip of the pair of the measuring holders can come close to each other.

In addition, there is further provided a guide roller which is provided at a circumference of at least one of the pair of the measuring holders for the purpose of guiding the movement of the tape measure.

In addition, there is further provided an indication window which is provided at the body for the purpose of visually checking the scales of the tape measure.

According to another example of the present invention, there are further provided a distance measuring sensor which is provided at the body and measures the distance that the tape measure moves; a computation part which computes the diameter of an object, which will be measured, based on the distance of the movement of the tape measure measured by the distance measuring sensor; and a display part which is provided at the body and displays a result of the computation of the computation part, so that it is possible to easily check a result of the measurement.

The tape measure has a plurality of scales indicating the diameters, thus measuring the diameter of an object which will be measured.

### ADVANTAGEOUS EFFECTS

According to the present invention, a worker can conveniently measure the diameter of an object, which will be measured, with one hand, and a measuring time can be shortened.

### BRIEF DESCRIPTION OF DRAWINGS

FIG. 1 is a perspective view illustrating a portable measuring instrument according to an embodiment of the present invention.

FIG. 2 is a cross sectional view of FIG. 1.

FIG. 3 is a view illustrating a state that a pair of measuring holders of FIG. 1 are spaced apart.

FIG. 4 is a view illustrating a use state of FIG. 1.

FIG. 5 is a cross sectional view illustrating a portable measuring instrument according to another embodiment of the present invention.

### MODES FOR CARRYING OUT THE INVENTION

The present invention will be described in details with reference to the accompanying drawings.

Before entering the descriptions, a tree is assumed as an object which will be measured.

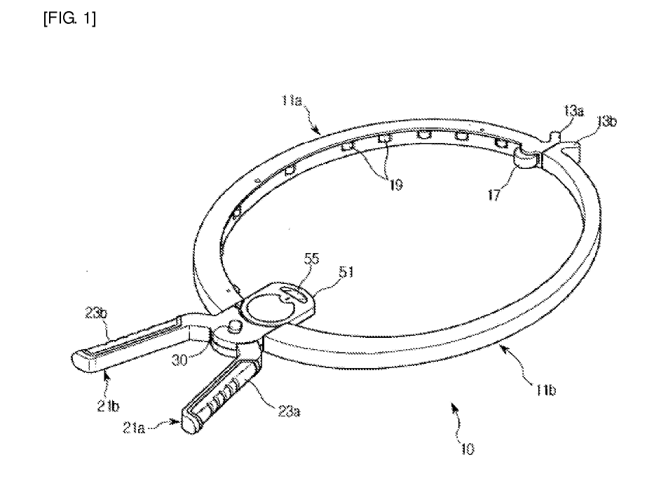

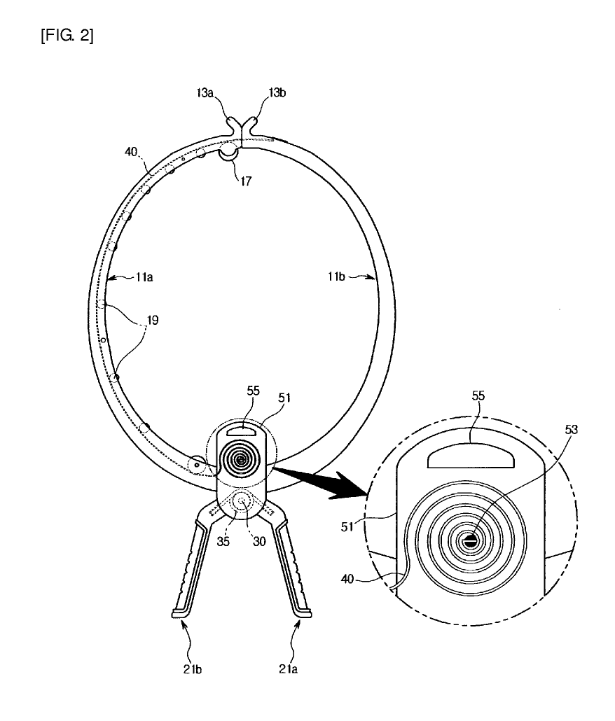

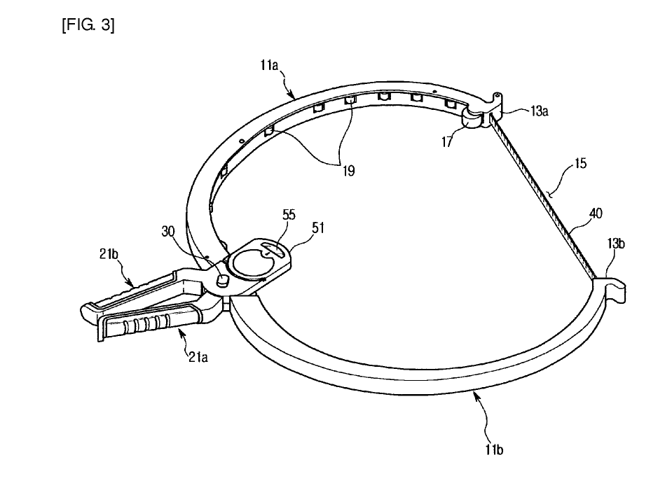

FIGS. 1 through 4 show a portable measuring instrument according to an embodiment of the present invention. As shown therein, the portable measuring instrument according to an embodiment of the present invention comprises a body 10 with a pair of measuring holders 11a and 11b and a pair of grips 21a and 21b, a rotation shaft 30 which rotatably engage the pair of the measuring holders 11a and 11b, and a tape measure 40 engaged to the body 10 in a winding or unwinding manner for the purpose of measuring the size of a tree which is an object to be measured.

The body 10 has a pair of measuring holders 11a and 11b and a pair of grips 21a and 21b spacing apart the pair of the measuring holders 11a and 11b.

The pair of the measuring holders 11a and 11b can come close to each other or can come distant from each other. For convenience, the measuring holder positioned at the left side in FIG. 1 is called a left side measuring holder 11a hereinafter, and the measuring holder positioned at the right side is called a right side measuring holder 11b. Each of the measuring holders 11a to and 11b has a certain curvature radius and is curved. The pair of the measuring holders 11a and 11b have elliptical cross sections and are arranged symmetrically, so they can come close to each or can come distant from each other for the purpose of partially accommodating or releasing a tree.

At the end portions of the pair of the measuring holders 11a and 11b are is provided tips 13a and 13b which come close to each other or come distant from each other. The tips 13a and 13b come close to each other and come distant from each other depending on the operations of the pair of the measuring holders 11a and 11b as they come into contact with the circumferences of the tree. In particular, when the tips 13a and 13b of the measuring holders 11a and 11b come distant from each other, an inlet and outlet port 15 is formed between the tips 13a and 13b of the measuring holders 11a and 11b for the purpose of allowing a tree to come in and go out. In addition, at the tip 13a of the left side measuring holder 11a is engaged a roller 17 in a rolling manner. As the roller 17 comes into rolling contact with the bark of a tree when measuring a tree, the trees can be protected from being hurt.

In addition, at an inner circumference of the left side measuring holder 11a is provided a guide roller 19 which guides the movement of the tape measure 40. The guide roller 19 is installed at the left side measuring holder 11a in such a way that it can roll depending on the movement of the tape to measure 40.

The pair of the grips 21a and 21b are longitudinally extended from the ends of the measuring holders 11a and 11b longer enough so that a worker can hold the same with one hand. When the pair of the grips 21a and 21b come close to each other, the pair of the measuring holders 11a and 11b come distant is from each other, and on the contrary, when the pair of the grips 21a and 21b come distant from each other, the pair of the measuring holders 11a and 11b come close to each since the grips 21a and 21b are alternately arranged with respect to each other about a rotary shaft 30. At the end portions of the pair of the grips 21a and 21b are engaged rubber bands 23a and 23b for preventing slipping.

The rotary shaft 30 passes through and rotatably engages at the end portions of the measuring holders 11a and 11b positioned at the opposite sides of the tops 13a and 13b.

At an outer circumferential portion of one region of the rotary shaft 30 is engaged at a spring 35 which is adapted as an elastic member. Both ends of the spring 35 are supported by one side where the grips 21a and 21b face each other so that the measuring holders 11a and 11b can come close to each other. The spring 35 serves to providing an elastic force by which the pair of the measuring holders 11a and 11b can always come close to each other. Here, the spring 35 is preferably formed of a torsion spring for a more effective operation.

So, the body 10 of the portable measuring instrument according to the present invention is formed in whole in a shape of tongs, so as the pair of the grips 21a and 21b come close to each other or come distant from each other, the inlet and outlet port 15 between the tips 13a and 13b of the pair of the is measuring holders 11a and 11b are open and closed. The tape measure 40 has a shape of a strap with a plurality of scales. As the measuring holders 11a and 11b come close to each other and come distant from each other, the tape measure 40 can come to surround the circumference of a tree depending on the approach and distancing operations of the measuring holders 11a and 11b, thus measuring the size of the tree. One end of the tape measure 40 is fixed at the right side measuring holder 11b and is wound on or unwound from the body 10 via the circumference of the left side measuring holder 11a after it crosses the pair of the tips 13a and 13b. The other end of the tape measure 40 is accommodated in and is wound on the housing 51 provided at the body 10 and is supported by a spiral spring 53. The tape measure 40 maintains a zero point state in a state that the pair of the tips 13a and 13b come into contact with each other, in other words, the inlet and outlet port 15 is closed. The present embodiment of the present invention is preferred to use a tape measure 40 with a plurality of scales each indicating a diameter, in other words, a pi-tape to measure for the purpose of easily measuring the diameter of a tree and reducing the time of measuring.

In addition, at one side of the body 10 close to the housing 51 is provided an indication window 55 for visually checking the scales of the tape measure 40.

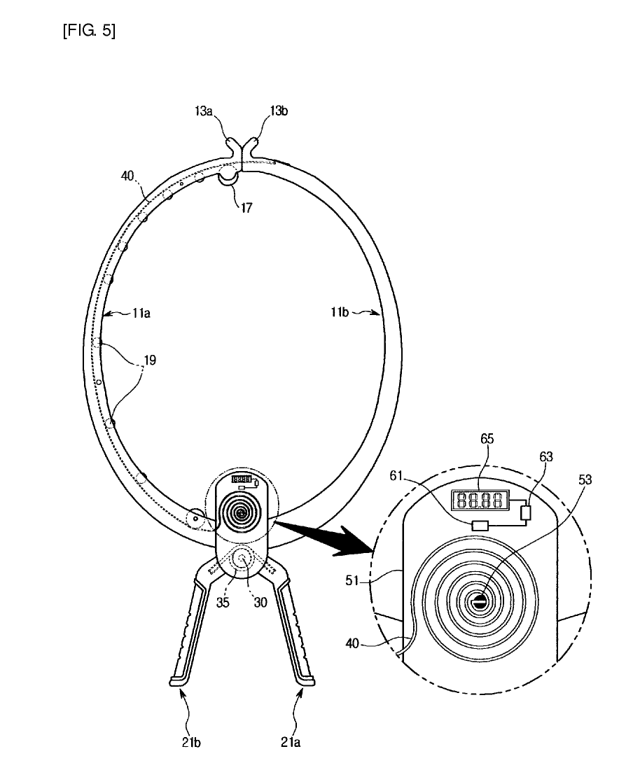

FIG. 5 is a view illustrating another embodiment of the potable is measuring instrument of the present invention. The portable measuring instrument according to another embodiment of the present invention comprises a distance measuring sensor 61 instead of the indication window 55 of the earlier described embodiment, and a computation part 63 and a display part 65 the construction of which is provided as a means for checking a result of the measurement.

The distance measuring sensor 61 is provided at the housing 51 in the vicinity of the tape measure 40, thus measuring the distance of the movement of the tape measure 40.

The computation part 63 is accommodated in the display part 65 for the purpose of computing the diameter of a tree based on the distance of the movement of the tape measure 40 measured from the distance measuring sensor 61 and helps transmit a result of the computation to the display part 65.

The display part 65 is supported by one side of the housing 51 and displays in numbers the diameter of a tree measured based on a signal of a result of the computation from the computation part 63.

Here, the distance measuring sensor 61, the computation part 63 and the display part 65 are electrically connected.

With reference to the above mentioned constructions, the procedure of measuring the diameter of a tree using a potable measuring instrument according to the present invention will be described.

In a zero point state that a pair of the tips 13a and 13b remain contacted with each other in the portable measuring instrument of the present invention, the pair of the tips 13a and 13b come into close contact with the bark of a tree.

When pressing for the pair of the grips 21a and 21b to come close to each other, the pair of the measuring holders 11a and 11b become widened about the rotary shaft 30, so the inlet and outlet port 15 formed by the tips 13a and 13b of the pair of the measuring holders 11a and 11b is opened.

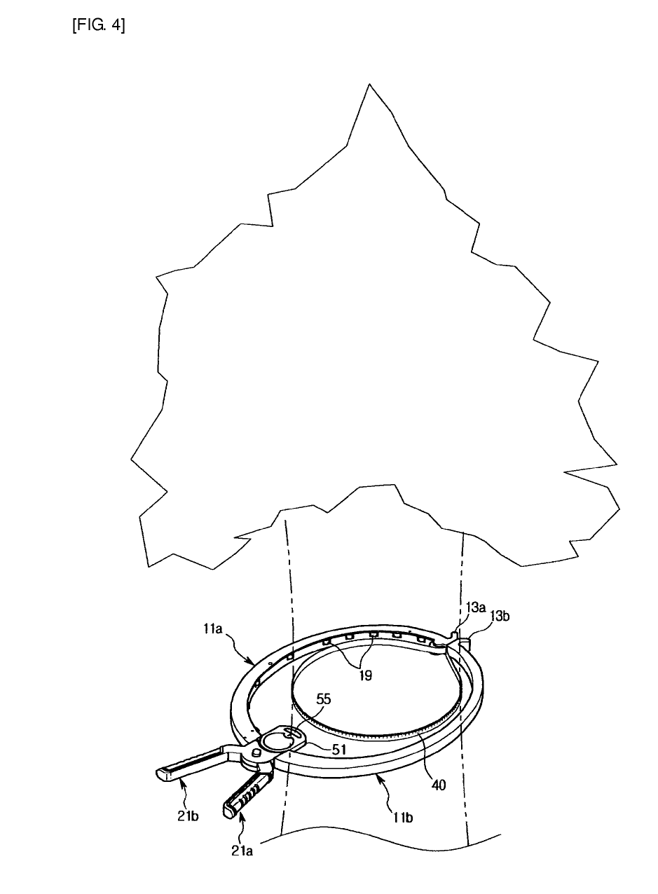

In a state that the inlet and outlet port 15 is opened, the portable measuring instrument moves along the circumference of a tree while accommodating the tree between the pair of the measuring holders 11a and 11b, and the pair of the tips 13a and 13b move rolling along the bark of the tree, and at this time the tape measure 40 wound in the housing 51 is drawn out and surrounds the circumference of the tree as shown in FIG. 4.

Each tip 13a, 13b is made to come into close contact in such a way to accommodate the tree between the pair of the measuring holders 11a and 11b and to close the inlet and outlet port 15, and a pressurizing state is so relieved that the pair of the grips 21a and 21b can space apart from each other.

When the pair of the grips 21a and 21b are relieved from a pressurizing state, the pair of the measuring holder 11a and 11b come into contact with each other about the rotary shaft 30 by means of the elastic force of the spring 35, and the pair of the tips 13a and 13b of the measuring holders 11a and 11b come into close contact with the bark of the tree and then directly contact with each other. Here, the tape measure forms a closed loop surrounding the circumference of the tree.

The worker visually checks the scales of the tape measure 40 drawn out from the housing 51 via the indication window 55, thus finally checking the diameter of the tree.

The pair of the grips 21a and 21b are pressurized following the measurement of the diameter of the tree, and the portable measuring instrument is separated from the tree in a state that the inlet and outlet port 15 is opened, so the portable measuring instrument is finally separated from the tree.

When the pair of the grips 21a and 21b are relieved from the pressurizing state, the pair of the measuring holders 11a and 11b come into close contact with each other by means of the elastic force of the spring 35, and the tips 13a and 13b come into contact with each other, so the portable measuring instrument of the present invention returns to its initial state before the measurement and keeps a zero point state.

So, the worker can easily measure the diameter of a tree with one hand, is and the measuring time can be saved.

In the above described embodiment, the portable measuring instrument according to the present invention has described that the diameter of the tree for landscape is measured as an object which will be measured; however the object to be measured is not limited thereto, so it might be adapted to a pipe having a circular cross section shape and an architecture material, a structure, etc.

In the above described, it has been described that the diameter of the object, which will be measured, is measured using the tape measure with a plurality of scales; however it is possible to measure the length of the circumference of the object, which will be measured, by using the tape measure with a plurality of scales which indicate the length instead of the diameter.

1. A potable measuring instrument, comprising:
a body which includes:
a pair of measuring holders which have tips coming into close contact with each other or coming distant from each other and are arranged opposite to each other for the purpose of accommodating or releasing an object which will be measured; and
a pair of grips which enable the pair of the measuring holders to be spaced apart from each other;
to a rotary shaft which engages the pair of the measuring holders to be rotatable; and
a tape measure which crosses the tips of the pair of the measuring holders and is wound on or unwound from the body and surrounds the circumference of the object, which will be measured, as the pair of the is measuring holders come into contact with or come distant from each other for thereby measuring the size of the object which will be measured.

2. A potable measuring instrument according to claim 1, further providing an elastic part which provides an elastic force so that each tip of the pair of the measuring holders can come close to each other.

3. A potable measuring instrument according to claim 1, further comprising a guide roller which is provided at a circumference of at least one of the pair of the measuring holders for the purpose of guiding the movement of the tape measure.

4. A potable measuring instrument according to claim 1, further comprising an indication window which is provided at the body for the purpose of visually checking the scales of the tape measure.

5. A potable measuring instrument according to claim 1, further comprising:
a distance measuring sensor which is provided at the body and measures the distance that the tape measure moves;
a computation part which computes the diameter of an object, which will be measured, based on the distance of the movement of the tape measure measured by the distance measuring sensor; and
a display part which is provided at the body and displays a result of the computation of the computation part.

6. A potable measuring instrument according to claim 1, wherein said tape measure has a plurality of scales indicating the diameters.
